(19) United States
(12) Patent Application Publication
(10) Pub. No.: US 2011/0233194 A1
(43) Pub. Date: Sep. 29, 2011

(54) PARTIAL HEAT-EMITTING BODY

(76) Inventors: Hyeon Choi, Daejeon (KR); Dong-Wook Lee, Daejeon (KR); Sang-Ki Chun, Daejeon (KR); Ki-Hwan Kim, Daejeon (KR); Young-Jun Hong, Daejeon (KR); In Seok Hwang, Daejeon (KR); Jin-Hyong Lim, Daejeon (KR); Su-Jim Kim, Daejeon (KR)

(21) Appl. No.: 13/131,415

(22) PCT Filed: Nov. 27, 2009
(86) PCT No.: PCT/KR09/07033

§ 371 Date: May 26, 2011

(30) Foreign Application Priority Data
Nov. 27, 2008 (KR) 2008-0119124

(51) Int. Cl. H05B 3/12; H05B 3/10

(52) U.S. Cl. 219/553; 219/552

(57) ABSTRACT

The present invention provides a partial heat-emitting body including a transparent substrate and a conductive heating element provided within a distance of 20 cm or less from at least one edge portion among edge portions of at least one surface of the transparent substrate.

### TECHNICAL FIELD

The present invention relates to a partial heat-emitting body and a method for manufacturing the same. More particularly, the present invention relates to a partial heat-emitting body that can be easily applied to a large area such as architectural glass and provide an excellent thermal insulation characteristic with low energy, and a method for manufacturing the same. This application claims priority from Korean Patent Application No. 10-2008-0119124 filed on Nov. 27, 2008 in the KIPO, the disclosure of which is incorporated herein by reference in its entirety.

### BACKGROUND ART

In recent years, with an energy crisis, improvement of a thermal insulation characteristic of a building has been more strongly required than ever. In particular, with development of architectural technology, glass tends to represent an increasing share of an exterior of the building. To this end, products that can improve the thermal insulation characteristic of glass have been significantly increased all over the world. For example, products in which glass is constituted by double layers or triple layers and Low-e glass having excellent thermal insulation performance using infrared reflection have been increasingly used.

Heat moves by methods of radiation, convection, and conduction. That is, the double-layered glass can improve the thermal insulation performance by minimizing conduction of air or charged gas between glass and glass, and the Low-e glass can minimize the loss of indoor heat to the outside by using a radiation path.

Air temperature of a floor is lower than that of a ceiling by the convection which is an indoor air flow. In particular, in glass that defines a boundary between an indoor area and an outdoor area, a cold temperature zone exists at a contact portion with the floor. That is, the cold zone is formed by a phenomenon called a cold draft, and the temperature of glass increases gradually from a part thereof close to the floor up to a part thereof in the vicinity of the ceiling. Further, since airtightness is not perfect during making a window, an edge portion of glass is lower in temperature than the center portion of glass.

### DISCLOSURE

### Technical Problem

The present invention has been made in an effort to provide a partial heat-emitting body that can be easily applied to a large area such as architectural glass, and a method for manufacturing the same.

### Technical Solution

The present invention provides a partial heat-emitting body including a transparent substrate and a conductive heating element provided within a distance of 20 cm or less from at least one edge portion among edge portions of at least one surface of the transparent substrate. The partial heat-emitting body may further include bus bars positioned at both ends of the conductive heating element and may further include a power supply connected with the bus bars. Further, the partial heat-emitting body may include an additional transparent substrate positioned on a surface thereof on which the conductive heating element is provided.

According to an exemplary embodiment of the present invention, the conductive heating element may be formed by a conductive heating pattern or a transparent conductive layer formed on the transparent substrate. According to another exemplary embodiment of the present invention, the conductive heating element may include a transparent film and a conductive heating pattern or a transparent conductive layer provided on the transparent film. In other words, the conductive heating element may be formed on the transparent substrate such as glass or a plastic film without an additional substrate and the conductive heating element may include a conductive heating pattern or a transparent conductive layer formed on an additional transparent film that be attached to the transparent substrate.

The conductive heating pattern included in the conductive heating element may have a regular pattern, but may have an irregular pattern. A line that configures the conductive heating pattern may be a straight line, but may be various modifications such as a curved line, a wave line, a zigzag line, and the like. The conductive heating pattern may be formed by printing, a photolithography process, a photography process, a mask process, and the like.

### ADVANTAGEOUS EFFECTS

According to the exemplary embodiments of the present invention, a partial element can be easily applied to a large area such as architectural glass and provide an excellent thermal insulation characteristic with low energy.

### DESCRIPTION OF DRAWINGS

FIG. 1 is a pattern diagram showing an offset printing process.

FIGS. 2 to 5 show a position of a conductive heating element of a partial heat-emitting body according to an exemplary embodiment of the present invention.

FIGS. 6 to 9 show positions of a conductive heating element and a bus bar of a partial heat-emitting body according to another exemplary embodiment of the present invention.

### BEST MODE

Hereinafter, the present invention will be described in detail.

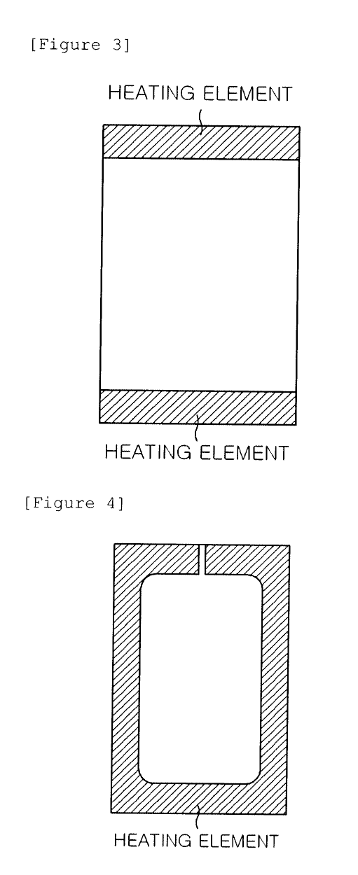

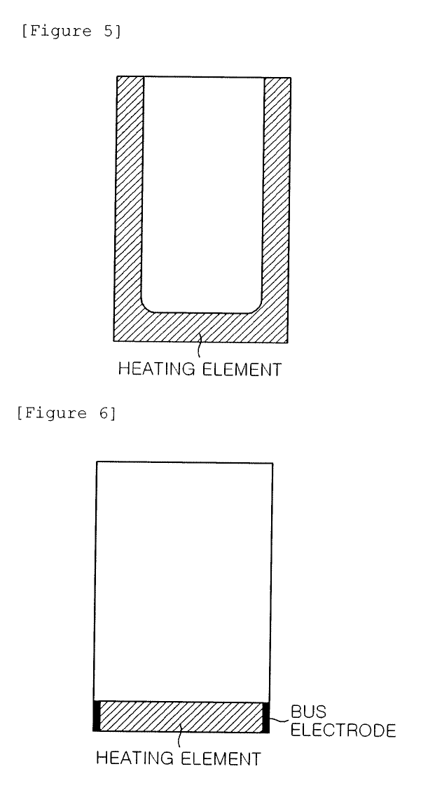

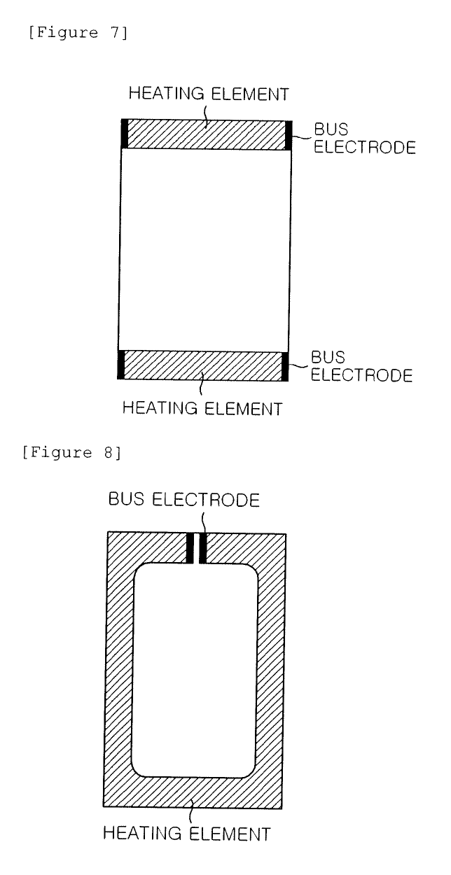

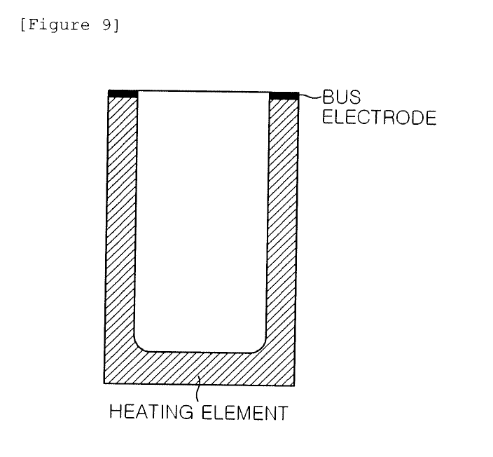

A partial heat-emitting body according to an exemplary embodiment of the present invention includes a conductive heating element provided within a distance of 20 cm from at least one edge portion among edge portions of at least one surface of a transparent substrate. The partial heat-emitting body according to the exemplary embodiment of the present invention may include the conductive heating element only at a lower edge portion as shown in FIG. 2 and may include the conductive heating element only at upper and lower edge portions as shown in FIG. 3. Further, the partial heat-emitting body may include the conductive heating element at four edge portions or three edge portions as shown in FIG. 4 or 5. Further, in the case where the partial heat-emitting body according to the exemplary embodiment of the present invention includes a bus bar, the partial heat-emitting body may have structures shown in FIGS. 6 to 9. However, the scope of the present invention is not limited to only the structures shown in the figures.

In the case of glass that is in contact with an indoor area where air is convected, the temperature of a floor portion or an edge portion of glass is lower than that of a center portion of glass. When the temperature of this portion is increased using the partial heat-emitting body, uniformity in temperature of glass may be increased, thereby minimizing a cold draft phenomenon. Therefore, it is possible to provide people with a pleasant environment even in the vicinity of a glass window.

Since a region in which the temperature is ununiform, such as the floor portion or edge portion is often within 20 cm from the edge portion, the conductive heating element is preferably provided within a distance of 20 cm from the edge portion. Meanwhile, in the case where the conductive heating element is formed only in a region which is less than 1 cm from the edge portion, the width of the formation area is small, and as a result, a heating pattern may not easily be formed. Accordingly, the partial heat-emitting body according to the exemplary embodiment of the present invention preferably includes a conductive heating element provided from a position distant from the edge portion by a distance of 1 to 20 cm to the edge portion. In the exemplary embodiment of the present invention, a transparent substrate is not particularly limited, but it is preferable to use the transparent substrate having light permeability of 50% or more and preferably 75% or more. Specifically, glass, a plastic substrate, or a plastic film may be used as the transparent substrate.

In the case where the plastic film is used as the transparent substrate, even though the plastic film has a large area, the plastic film can be easily stored or transported by using methods of winding, and the like. The plastic film may be directly used, but may be used with being attached to large-area glass used in a building, and the like.

In the case where glass is used as the transparent substrate, a conductive heating pattern or a transparent conductive layer may be formed at the edge portion of glass without an additional substrate, but the conductive heating pattern or transparent conductive layer is formed on an additional transparent film such as the plastic film to additionally manufacture the conductive heating element and thereafter, the conductive heating element is attached to the edge portion of the glass to preferably manufacture the partial heat-emitting body according to the exemplary embodiment of the present invention. In the conductive heating element, the conductive heating pattern or transparent conductive layer may be formed on the entire surface of the additional transparent film, and the conductive heating pattern or transparent conductive layer may be formed on at least one portion of the transparent film according to a purpose.

A material that is known in the art may be used as the plastic film, and for example, there are the film that has the visible ray permeability of 80% or more such as Polyethylene terephthalate (PET), polyvinylbutyral (PVB), polyethylene naphthalate (PEN), polyethersulfon (PES), and polycarbonate (PC), and it is preferable that the thickness thereof is 10 to 450 micrometers.

As described above, the conductive heating element may be formed by the conductive heating pattern or transparent conductive layer formed on the transparent substrate and may include an additional transparent film other than the transparent substrate and the conductive heating pattern or transparent conductive layer provided on the transparent film. Herein, as the transparent film, the plastic film described above may be used.

In a partial heat-emitting body according to an exemplary embodiment of the present invention, the transparent substrate may be the glass or plastic substrate, and the conductive heating element may be the conductive heating pattern or transparent conductive layer formed on the edge portion of the transparent substrate.

In a partial heat-emitting body according to another exemplary embodiment of the present invention, the transparent substrate may be the plastic film, and the conductive heating element may be the conductive heating pattern or transparent conductive layer formed on the edge portion of the transparent substrate.

In a partial heat-emitting body according to yet another exemplary embodiment of the present invention, the transparent substrate may be the glass, plastic substrate, or plastic film, the conductive heating element may include the conductive heating pattern or transparent conductive layer provided on the transparent film, and the conductive heating element may be attached within a distance of 20 cm from at least one edge portion among the edges of at least one surface of the transparent substrate. When the conductive heating element adheres to the transparent substrate, a tacky film or an adhesive film to be described below may be used.

The conductive heating pattern or transparent conductive layer of the conductive heating element is preferably manufactured using a transparent conductive material. Examples of the transparent conductive material may include ITO and ZnO based transparent conductive oxides. Further, an opaque conductive material may be coated and used with a thickness of 1 to 100 nm. As the opaque conductive material, Ag, Au, Cu, Al, and carbon nanotube may be used.

A part which is not transparent but does not have a pattern by patterning an opaque heating element is formed in 50% or more and preferably 75% or more or coated with a thin film to improve permeability. It is preferable that the line width of the conductive heating pattern of the conductive heating element is 100 micrometers or less, preferably 30 micrometers or less, more preferably 25 micrometers or less, and 5 micrometers or more. An interval between lines of the conductive heating pattern is preferably 50 micrometers to 30 mm and preferably 200 micrometers to 1 mm. The heights of the lines are preferably 1 to 100 micrometers, and more preferably 3 micrometers.

The conductive heating pattern may have a regular form or an irregular form. For example, the form may be a stripe, a rhombus, a quadrangular grid, a circle, a wave pattern, a grid, a 2D grid, and the like and is not limited to a predetermined form. Further, if the conductive heating pattern should be designed so that light emitted from a predetermined light source does not hinder an optical property by refraction and interference, a pattern in which the pattern regularity is minimized may be used and for this, the wave pattern, a sine wave, and a pattern in which spacing of a grid structure and the thickness of the line are configured irregularly may be used. In order to further improve the optical property, various patterns may be added in addition to the patterns. Further, additional dot patterns may be irregularly formed while not being connected to the above patterns. In this case, the patterns and the dot patterns preferably have the size of 30 micrometers or less. If necessary, the heating pattern may be a combination of two or more patterns. The conductive heating pattern may include a Voronoi pattern or Theloni pattern. The line that configures the conductive heating pattern may be a straight line, but may be various modifications such as a curved line, a wave line, and a zigzag line.

The partial heat-emitting body according to the exemplary embodiment of the present invention may be connected to a power supply for heat emission, and in this case, a heating value is 50 to 1000 W per m², and preferably 200 to 700 W per m². In general, under natural convection situation (routinely, an indoor environment), the temperature may be increased by approximately 2 to 3° C. at 50 W per m². Accordingly, if the partial heat-emitting body according to the exemplary embodiment of the present invention has a temperature rise effect lower than the natural convection situation, a technical meaning is reduced. Further, in the case where the heating value is over 1000 W, the temperature may be increased to approximately 50° C., and as a result, an effective value is not high in terms of power consumption. Therefore, an economical meaning is low. The partial heat-emitting body according to the exemplary embodiment of the present invention may operated regardless of voltage, but may be used preferably at low voltage, e.g., 30 V or lower, and more preferably 20 V or lower. Sheet resistance in the heating element is 1000 ohm/square or less, preferably 10 ohm/square or less, and more preferably 1 ohm/square or less.

The partial heat-emitting body according to the exemplary embodiment of the present invention may be applied to glass that is used for various transport means such as vehicles, ships, railroads, high-speed railroads, and airplanes, houses or other buildings, and in particular, may be easily applied to large-area glass.

The tacky film or the adhesive film may be provided on at least one surface of the partial heat-emitting body according to the exemplary embodiment of the present invention so as to be applied to the large-area glass such as architectural glass. The tacky film or the adhesive film may be made of acrylate-based and silicon-based materials and the thickness thereof is preferably 1 to 300 micrometers. The heating element having the tacky film or the adhesive film may be attached to glass by a lamination method. In this case, a release film may be provided on one surface of the tacky film or the adhesive film before being attached to glass.

The partial heat-emitting body according to the exemplary embodiment of the present invention may be manufactured as a conjugate by attaching the transparent substrate with the conductive heating element to an additional transparent substrate by using the adhesive film. For example, the adhesive film may include a PVB film, an EVA film, a PU film, and the like, but the adhesive film is not limited thereto. The adhesive film is not particularly limited, but the thickness thereof is preferably in the range of 200 to 800 micrometers. In the case where the transparent substrate is glass, it is possible to implement safety glass by manufacturing the conjugate by using the adhesive film.

A formation method of the partial heat-emitting body according to the exemplary embodiment of the present invention is various. That is, transparent conductive oxide and metallic material may be formed as the conductive heating element by a sputtering method. In the case where a metallic layer is formed as the heating pattern included in the conductive heating element, the heating pattern may be a multilayer structure including the metallic layer in order to control permeability and a passivation layer may be formed in order to form a coating film in the multilayer structure. Further, the material such as carbon nanotube may form the heating pattern through a wetting process after preparing a coating solution.

The conductive heating element of the partial heat-emitting body according to the exemplary embodiment of the present invention may be formed by a printing method, a photolithography method, a photography method, a mask method, and the like.

The printing method may be performed by using a method in which a paste including a conductive heating material is transferred on the transparent substrate in a desired pattern form and sintered. The transferring method is not particularly limited, but the above pattern form is formed on a pattern transferring medium such as a base plate or a screen and the desired pattern may be transferred on the transparent substrate thereby. A method of forming the pattern form on the pattern transferring medium may be performed by using a method that is known in the art.

The printing method is not particularly limited, and printing methods such as offset printing, screen printing, gravure printing, and the like may be used. The offset printing may be performed by using the method in which after the paste is filled in the base plate on which the pattern is formed, primary transferring is performed by using silicon rubber that is called the blanket, and secondary transferring is performed by closely contacting the blanket and the transparent substrate. The screen printing may be performed by using a method in which after the paste is disposed on the screen on which the pattern is formed, the paste is directly disposed on the substrate through the screen that has the space while the squeeze is pushed. The gravure printing may be performed by using a method in which the paste is filled in the pattern while the blanket where the pattern is formed on the roll is wound, and thereafter, the paste is transferred on the transparent substrate. In the exemplary embodiment of the present invention, the above method may be used and the above methods may be used in combination. In addition, other printing methods that are known to those who are skilled in the art may be used.

In the case of the offset printing method, because of a release property of the blanket, the paste is most transferred on the transparent substrate such as glass, such that an additional blanket washing process is not required. The base plate may be manufactured by precisely etching glass on which a desired conductive heating pattern is formed, and metal or diamond-like carbon (DLC) coating may be performed on a glass surface for durability. The base plate may be manufactured by etching a metal plate.

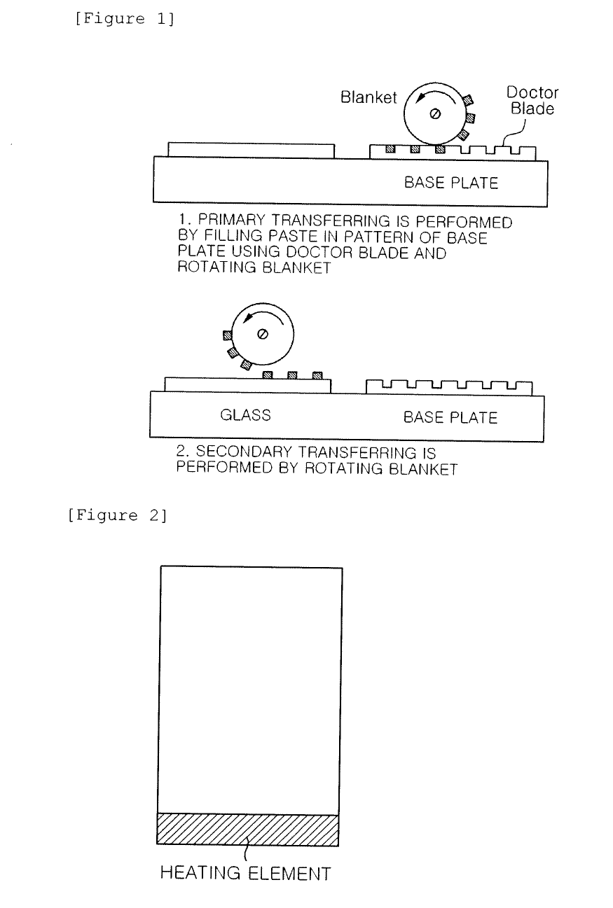

In the exemplary embodiment of the present invention, in order to implement the more precise conductive heating pattern, the offset printing method is preferably used. FIG. 1 shows the offset printing method. According to FIG. 1, after the paste is filled in the pattern of the base plate by using the doctor blade as a first step, the primary transferring is performed by rotating the blanket, and the secondary transferring is performed on the glass surface by rotating the blanket as a second step.

In the exemplary embodiment of the present invention, the forming method of the conductive heating pattern is not limited to the above printing method, and the photolithography process may be used. For example, the photolithography process may be performed by using the method in which a conductive heating pattern material layer is formed on the entire surface of the transparent substrate, a photoresist layer is formed thereon, the photoresist layer is patterned by a selective exposure and development process, the conductive heating pattern material layer is patterned by using the patterned photoresist layer as a mask, and the photoresist layer is removed.

The present invention may also use the photography method. For example, after a picture photosensitive material that includes silver halide is applied onto the transparent substrate, the pattern may be formed by selectively exposing and developing the photosensitive material. A more detailed example will be described below. First, the photosensitive material for negative is coated on a substrate on which the pattern will be formed. In this case, as the substrate, polymer films such as PET, acetyl celluloid, and the like may be used. The polymer film material on which the photosensitive material is applied will be referred to as the film. The photosensitive material for negative may be generally composed of silver halide in which AgBr that is very sensitive to light and regularly reacted thereto and a small amount of AgI are mixed with each other. Since an image that is developed by picturing the general photosensitive material for negative is a negative picture that is opposite to a subject in terms of light and shade, the picturing may be performed by using the mask that has the pattern form that will be formed and preferably irregular pattern form.

In order to increase the conductivity of the heating pattern that is formed by using the photolithography and photography processes, a plating treatment may be further performed. The plating may use an electroless plating method, copper or nickel may be used as a plating material, and after copper plating is performed, nickel plating may be performed thereon, but the scope of the present invention is not limited only thereto.

The present invention may use the method using the mask. For example, after the mask that has the heating pattern is disposed close to the substrate at all times, the mask may be patterned by using a method of depositing the heating pattern material. In this case, the depositing method may use a physical vapor deposition (PVD) method by heat or an electron beam or a chemical vapor deposition (CVD) method using an organometal material.

In the exemplary embodiment of the present invention, metal that has excellent thermal conductivity is preferably used as the conductive heating material. In addition, a specific resistance value of the conductive heating material is preferably in the range of 0.1 microOhm·cm to 20 miliOhm·cm. As a detailed example of the conductive heating material, copper, silver, and the like may be used, and silver is the most preferable. The conductive heating material may be used in a particle form. In the exemplary embodiment of the present invention, as the conductive heating material, copper particles that are coated with silver may be also used.

In the exemplary embodiment of the present invention, in the case where the paste that includes the conductive heating material is used, the paste may further include an organic binder in addition to the aforementioned conductive heating material so as to easily perform the printing process. The organic binder preferably has a volatile property in the sintering process. As the organic binder, there are used polyacryl-based resin, polyurethane-based resin, polyester-based resin, polyolefine-based resin, polycarbonate-based resin, cellulose resin, polyimide-based resin, polyethylene naphthalate-based resin, denatured epoxy, and the like, but it is not limited thereto.

In order to improve the attachment ability of the paste to the transparent substrate, the paste may further include glass frit. The glass frit may be selected from commercial products, but it is preferable to use the environmentally friendly glass frit without lead component. In this case, it is preferable that the average diameter of the used glass frit is 2 micrometers or less and the maximum diameter thereof is 50 micrometers or less.

If necessary, a solvent may be further added to the paste. As the solvent, there are butyl carbitol acetate, carbitol acetate, cyclohexanon, cellosolve acetate, terpineol, and the like, but the scope of the present invention is not limited thereto.

In the exemplary embodiment of the present invention, in the case when the paste that includes the conductive heating material, organic binder, glass frit and solvent is used, it is preferable that the weight ratio of the conductive heating material is 50 to 90%, the weight ratio of the organic binder is 1 to 20%, the weight ratio of the glass frit is 0.1 to 10%, and the weight ratio of the solvent is 1 to 20%.

It may be formed so that the line width of the line forming the conductive heating element pattern is 100 micrometers or less, preferably 30 micrometers or less, and more preferably 25 micrometers or less by using the above material.

In the exemplary embodiment of the present invention, in the case when the above paste is used, when the paste is printed and sintered, the heating pattern that has the conductivity is formed. In this case, the sintering temperature is not particularly limited, but may be 500 to 800° C. and preferably 600 to 700° C. In the case where the substrate that forms the heating pattern is glass, if necessary, in the above sintering step, the glass may be shaped for the purpose of construction or vehicles. For example, in a step of shaping the glass for vehicles in a curved line, the paste may be sintered. In addition, in the case where the plastic film is used as the substrate that forms the conductive heating pattern, it is preferable that the sintering is performed at a relatively low temperature. For example, the sintering may be performed at 50 to 350° C.

In a method of manufacturing the partial heat-emitting body according to an exemplary embodiment of the present invention, a step of forming the bus bar at both ends of the conductive heating element and a step of preparing a power supply that is connected to the bus bar may be further performed. These steps may use the methods that are known in the art. For example, the bus bar may be simultaneously formed in conjunction with the formation of the conductive heating element, and may be also formed by using another printing method after the conductive heating element is formed. For example, after the conductive heating element is formed by using the offset printing method, the bus bar may be formed through the screen printing. In this case, the thickness of the bus bar is appropriately 1 to 100 micrometers and preferably 10 to 50 micrometers. If the thickness of the bus bar is less than 1 micrometer, the contact resistance between the conductive heating element and the bus bar is increased, such that heat may be locally emitted from a contact portion, and if the contact resistance is more than 100 micrometers, the cost of an electrode material is increased. The connection between the bus bar and the power supply may be made through soldering and physical contact with the structure that has good conductive heat emission. As described above, in the exemplary embodiment of the present invention, the manufacturing method is not limited to the printing method and the processing using the photolithography method, the photography method, and the mask may be used.

The heating element and the bus electrode may be formed at positions shown in FIGS. 2 to 5. Further, as shown in FIGS. 4 and 5, it is preferable that a region of the conductive heating element at a corner portion is rounded or a resistance value between the conductive heating element and the corner portion is controlled, in order to prevent local heat emission from the corner portion. The rounding processing and the resistance value controlling are to prevent excessive local heat emission and the processing and controlling degree may be determined by those skilled in the art depending on a local heat emission degree.

### MODE FOR INVENTION

### Example 1

The photosensitive material for negative was applied onto PET on which the pattern will be formed. The photosensitive material for negative was composed of silver halide in which AgBr that was very sensitive to light and regularly reacted thereto and a small amount of AgI were mixed with each other. As a pattern formed on the PET, a grid pattern of a 300-micrometer pitch was used. By using a negative mask in which light penetrates a designed pattern area and light does not penetrate an area other than the pattern, light was irradiated to a PET film having a photosensitive pattern for negative according to the set exposure time and the intensity of light. By this process, photosensitive silver on a photosensitive emulsion layer was photosensitized to form a latent image. The formed latent image was formed as a visible image which is opposite to the mask by converting photosensitive silver into blackened silver through the development process. The line width and line height of the grid pattern made of the blackened silver, which is formed on the PET film through the photography process were 20 micrometers and 6.5 micrometers, respectively, and the permeability thereof was 76%. The film was cut in 500 mm×60 mm and laminated onto 800 mm×500 mm glass in a form shown in FIG. 2 by using a tacky film or an adhesive film. The sheet resistance of the film was 0.2 ohm/square and the resistance between both terminals of a bus electrode was 1.7 ohm. In this case, when the voltage of 5 V was applied, a heating value was 14.7 W (490 W/m²). As a result of the measurement of the heating phenomenon by using an IR vision camera, the temperature was increased up to 50° C. within 20 minutes.

### Example 2

An ITO film having sheet resistance of 100 ohm/square was formed on a surface without the adhesive film through sputtering by using the PET film with the adhesive film attached thereto. The ITO film was cut with a width of 60 mm and laminated onto the 800 mm×500 mm glass in a form shown in FIG. 5. In this case, the resistance between both terminals of the bus electrode was 160 ohm. In this case, when the voltage of 50 V was applied, the heating value was 15.7 W (520 W/m²). As a result of the measurement of the heating phenomenon by using the IR vision camera, the temperature was increased up to 55° C. within 20 minutes.

### Example 3

The film formed in Example 1 was cut with a width of 60 mm and laminated onto the 800 mm×500 mm glass in the form shown in FIG. 5. The resistance between both terminals of the bus electrode was 9 ohm. In this case, when the voltage of 22 V was applied, the heating value was 54 W (450 W/m²). As a result of the measurement of the heating phenomenon by using the IR vision camera, the temperature was increased up to 50° C. within 20 minutes.

1. A partial heat-emitting body, comprising:
a transparent substrate; and
a conductive heating element provided on at least one surface of the transparent substrate within a distance of 20 cm or less from at least one edge portion of the transparent substrate.

2. The partial heat-emitting body according to claim 1, wherein the transparent substrate is glass, a plastic substrate, or a plastic film and the conductive heating element is a conductive heating pattern or a transparent conductive layer formed on the edge portion of the transparent substrate.

3. The partial heat-emitting body according to claim 1, wherein the transparent substrate is the glass, plastic substrate, or plastic film, the conductive heating element includes a transparent film, and a conductive heating pattern or a transparent conductive layer provided on the transparent film, and the conductive heating element is attached within a distance of 20 cm or less from at least one edge portion among edges of at least one surface of the transparent substrate.

4. The partial heat-emitting body according to claim 1, wherein the conductive heating element includes a conductive heating pattern of a regular form or an irregular form.

5. The partial heat-emitting body according to claim 1, wherein the conductive heating element further includes bus bars positioned at both ends thereof and an electrode including a power supply connected with the bus bars.

6. The partial heat-emitting body according to claim 1, wherein the conductive heating element includes a conductive heating pattern including a transparent or opaque conductive material having a specific resistance value of 0.1 microOhm·cm to 20 miliOhm·cm.

7. The partial heat-emitting body according to claim 1, wherein the conductive heating element includes a conductive heating pattern including at least one of a transparent conductive material, Ag, Au, Cu, Al, and carbon nanotube.

8. The partial heat-emitting body according to claim 1, wherein the conductive heating element includes a conductive heating pattern in which a line width is 100 micrometers or less, an interline interval is in the range of 50 micrometers to 30 mm, and a line height is in the range of 1 to 100 micrometers.

9. The partial heat-emitting body according to claim 1, wherein the conductive heating element includes a conductive heating pattern formed through sintering after a pattern is formed by a paste including a conductive heating material, an organic binder, glass frit, and a solvent.

10. The partial heat-emitting body according to claim 1, wherein the conductive heating element has a heating value in the range of 50 to 1000 W per m² and resistance of 1000 ohm/square or less.

11. The partial heat-emitting body according to claim 1, wherein a tacky film or an adhesive film is additionally provided on a surface of the transparent substrate on which the conductive heating element is provided.

12. The partial heat-emitting body according to claim 11, wherein a release film is additionally provided on the tacky film or the adhesive film.

13. The partial heat-emitting body according to claim 1, further comprising a transparent substrate provided on a surface thereof with the conductive heating element.

14. The partial heat-emitting body according to claim 13, wherein the tacky film or the adhesive film is provided between the surface with the additional transparent substrate and the surface with the conductive heating element.
